(19) United States
(12) Patent Application Publication
(10) Pub. No.: US 2026/0051708 A1
(43) Pub. Date: Feb. 19, 2026

(54) ELECTRICAL CONNECTOR AND METHOD FOR MANUFACTURING ELECTRICAL CONNECTOR

(71) Applicant: MITSUMI ELECTRIC CO., LTD., Tokyo (JP)

(72) Inventors: Tsubasa OKAMOTO, Tokyo (JP); Shinichi TAMURA, Tokyo (JP); Takeshi NODA, Tokyo (JP)

(21) Appl. No.: 19/304,126

(22) Filed: Aug. 19, 2025

(30) Foreign Application Priority Data
Aug. 19, 2024 (JP) 2024-137644
Dec. 2, 2024 (JP) 2024-209241

(51) Int. Cl. H01R 24/38; H01R 103/00

(52) U.S. Cl. CPC H01R 24/38; H01R 2103/00; H01R 2201/26

(57) ABSTRACT

An electrical connector includes a contact pin, an insulating housing including a cylindrical holding portion for holding the contact pin therein and a cylindrical protruding portion protruding from a tip end surface of the holding portion toward a tip side, an outer contact including a cylindrical base portion for holding the holding portion of the housing therein, a first cylindrical portion linearly extending from a tip end surface of the base portion toward the tip side, and a second cylindrical portion linearly extending from the base portion toward a base side, and a first sealing member provided in the second cylindrical portion of the outer contact to seal a gap between the contact pin and the housing and a gap between the housing and the outer contact.

### CROSS-REFERENCE TO RELATED APPLICATIONS

The present application claims priorities to Japanese Patent Application No. 2024-137644 filed on Aug. 19, 2024, and Japanese Patent Application No. 2024-209241 filed on Dec. 2, 2024. The contents of each of the above-listed applications are hereby incorporated by reference for all purposes.

### TECHNICAL FIELD

The present disclosure generally relates to electrical connectors and methods for manufacturing electrical connectors, in particular to an electrical connector for providing a coaxial connection between a plug connector connected to a coaxial cable of an electronic device such as an in-vehicle camera and a plug connector connected to a coaxial cable of a control device that receives input from the electronic device, and a method for manufacturing the electrical connectors.

### BACKGROUND ART

In recent years, an in-vehicle camera has been mounted on a vehicle, and images of surroundings of the vehicle captured by the in-vehicle camera can be used for automated driving and driving assistance, among other applications. The in-vehicle camera usually includes a camera housing, a circuit board provided in the camera housing, an image sensor such as a CCD or a CMOS sensor mounted on the circuit board, and an imaging optical system provided in front of the image sensor. Such an in-vehicle camera can be attached to various locations (e.g., a front bumper and a rear bumper) of the vehicle and connected to an ECU (Electronic Control Unit) for controlling operations of the vehicle to transmit a captured image to the ECU and receive electric power and instructions from the ECU.

In order to provide a connection between the in-vehicle camera and the ECU, it is necessary to provide an electrical connection between a connection cable extending from the circuit board of the in-vehicle camera and a connection cable extending from the ECU. At this time, in order to realize a required environmental resistance performance of the in-vehicle camera such as improvement of reliability of the connection, waterproofing of the connection and improvement of impact resistance performance, there has been used an electrical connector (an adapter connector) for relaying the electrical connection between the connection cable of the circuit board of the in-vehicle camera and the connection cable of the ECU.

Further, as the number of pixels of the in-vehicle camera has increased in recent years, an amount of data transmitted from the in-vehicle camera to the ECU has also increased. In order to transmit a large amount of data in a short time, it is necessary to exchange a high-frequency signal between the in-vehicle camera and the ECU. Thus, there are needs to improve electrical characteristics of the connection between the in-vehicle camera and the ECU. In particular, there are needs to improve transmission characteristics in a high-frequency band. In response to such needs, patent document 1 discloses an electrical connector 500 shown in FIG. 1. The electrical connector 500 is an adapter connector for providing a coaxial connection between a plug connector connected to an end portion of a coaxial cable of the in-vehicle camera and a plug connector connected to an end portion of a coaxial cable of the ECU. As is well known in the art, a coaxial connection using a coaxial cable has higher transmission characteristics in the high-frequency band as compared with a connection using a plurality of terminals. By connecting the in-vehicle camera and the ECU with the coaxial connection using the coaxial cable, it is possible to improve the transmission characteristics of the connection between the in-vehicle camera and the ECU in the high-frequency band.

As shown in FIG. 1, the electrical connector 500 includes a contact pin 510, a cylindrical insulating housing 520 for holding the contact pin 510 therein, a metal outer contact 530 for holding the insulating housing 520 therein, a metal flange portion 540 extending from an outer peripheral surface of the outer contact 530 toward an outer side, a metal cover portion 550 extending from the flange portion 540 so as to surround the outer contact 530 from the outer side with a gap therebetween, a through-hole 560 formed in the flange portion 540, a fixing bolt 570, and a gasket 580 provided on the outer contact 530.

The electrical connector 500 is mounted on a plate-like support member 600 so that the outer contact 530 can be inserted into a through-hole 610 formed in the support member 600. As a result, one end portion of the contact pin 510 and one end portion of the outer contact 530 are exposed toward a space on the left side of the support member 600 in the figure. The other end portion of the contact pin 510 and the other end portion of the outer contact 530 are exposed toward a space on the right side of the support member 600 in the figure. Thus, by bringing the contact pin 510 and the outer contact 530 into contact respectively with a contact pin and an outer contact of the plug connector connected to the coaxial cable of the in-vehicle camera, and with a contact pin and an outer contact of the plug connector connected to the coaxial cable of the ECU, it is possible to provide the coaxial connection between the coaxial cable of the in-vehicle camera and the coaxial cable of the ECU. Further, by press-fitting the fixing bolt 570 into a through-hole 620 formed in the support member 600 in a state in which the fixing bolt 570 is passed through the through-hole 560, the electrical connector 500 is fixed on the support member 600. Further, a gap between the through-hole 610 of the support member 600 and the outer contact 530 of the electrical connector 500 is liquid-tightly sealed by the gasket 580, thereby providing waterproof performance of the electrical connector 500.

As described above, the gap between the through-hole 610 of the support member 600 and the outer contact 530 of the electrical connector 500 is liquid-tightly sealed by the gasket 580. However, in a configuration of the electrical connector 500, a gap between the contact pin 510 and the insulating housing 520 and a gap between the insulating housing 520 and the outer contact 530 are not liquid-tightly sealed. Thus, it is not possible to provide waterproof performance inside the outer contact 530. Ingress of water or dust from one side to the other inside the outer contact 530 may cause a reduction in connection reliability of the electrical connector 500 and shorten product lifetime of the electrical connector 500.

In addition, as the number of pixels of the in-vehicle camera increases, the amount of data transmitted from the in-vehicle camera to the ECU has increased, and there is a need to improve communication speed between the in-vehicle camera and the ECU. In response to such needs, an electrical connector compliant with a Mini Coaxial standard (a miniature coaxial connector) is now used in place of a conventional FAKRA standard electrical connector for the coaxial connection between the in-vehicle camera and the ECU. The electrical connector compliant with the Mini Coaxial standard is smaller than the electrical connector compliant with the FAKRA standard and enables higher-speed signal transmission than the electrical connector compliant with the FAKRA standard.

FIG. 2 shows a schematic cross-sectional view showing a structure of an electrical connector 700 compliant with the Mini Coaxial standard. FIG. 2 shows a portion of the electrical connector 700 located on one side. A plug connector connected to the coaxial cable of the ECU that communicates with the in-vehicle camera is coupled with the portion of the illustrated electrical connector 700 located on the one side. On the one side connected to the coaxial cable of the ECU, an insulating housing 730 holds a contact pin 710 and is held in an outer contact 720. The Mini Coaxial standard requires that the insulating housing 730 includes a cylindrical holding portion 740 for holding the contact pin 710 and a protruding portion 750 protruding from a tip end surface of the holding portion 740 toward a tip side. The protruding portion 750 covers a base side portion of an exposed portion of the contact pin 710 from the outer side. The Mini Coaxial standard defines a shape of the protruding portion 750 and a protruding amount of the protruding portion 750 from the holding portion 740 toward the tip side (for example, 0.15 mm). Thus, in the Mini Coaxial standard, a structure of the one side of the electrical connector 700 to be coupled with the plug connector connected to the coaxial cable of the ECU is strictly specified. Therefore, it is impossible to provide an additional member inside the outer contact 720 on the one side connected to the coaxial cable of the ECU for liquid-tightly sealing a gap between the contact pin 710 and the insulating housing 730 and a gap between the insulating housing 730 and the outer contact 720.

In addition, in a structure of the electrical connector 500 shown in FIG. 1, a gap between the fixing bolt 570 and the through-hole 560 and a gap between the fixing bolt 570 and the through-hole 620 of the support member 600 are not liquid-tightly sealed. Thus, the waterproof performance of the electrical connector 500 is insufficient. Further, in the structure of the electrical connector 500, the cover portion 550 is formed from a metallic material and is formed integrally with the flange portion 540. Thus, when a twisting operation, a tilting operation, or vibration is applied to the plug connector inserted into the cover portion 550, there has been a problem in that the cover portion 550 may be deformed or the flange portion 540 may lift from the support member 600, and thus the connection reliability of the electrical connector 500 is reduced and the product lifetime of the electrical connector 500 is shortened.

### RELATED ART DOCUMENT

### Patent Document

Patent document 1: JP 2001-326017 A

### SUMMARY

### Problems to be Solved

The present disclosure has been made in view of the above-described conventional problems. Accordingly, it is an object to provide an electrical connector having excellent waterproof performance and a method for manufacturing the electrical connector.

### Means for Solving the Problem

The above object is achieved by the present disclosure defined by the following (1) to (3).
(1) An electrical connector for providing a coaxial connection between a first plug connector to be inserted from a tip side and a second plug connector to be inserted from a base side, the electrical connector comprising:
a contact pin including:
   a first contact portion linearly extending in an insertion and extraction direction of the first plug connector and the second plug connector and configured to contact a contact pin of the first plug connector,
   a press-fitted portion extending from the first contact portion toward the base side, and
   a second contact portion linearly extending from the press-fitted portion toward the base side and configured to contact a contact pin of the second plug connector;
an insulating housing including:
   a holding portion into which the press-fitted portion of the contact pin is press-fitted,
   a protruding portion protruding from a tip end surface of the holding portion toward the tip side and covering a base side portion of the first contact portion of the contact pin from an outer side, and
   a through-hole that passes through the holding portion and the protruding portion in the insertion and extraction direction and through which the contact pin is passed;
an outer contact including:
   a base portion for holding the holding portion of the housing therein,
   a first cylindrical portion linearly extending from a tip end surface of the base portion toward the tip side and configured to contact an outer contact of the first plug connector,
   a second cylindrical portion linearly extending from the base portion toward the base side and configured to contact an outer contact of the second plug connector, and
   a through-hole that passes through the base portion, the first cylindrical portion, and the second cylindrical portion in the insertion and extraction direction and in which the contact pin and the housing are located; and
a first sealing member provided in the second cylindrical portion of the outer contact to seal a gap between the contact pin and the housing and a gap between the housing and the outer contact.
(2) A method of manufacturing an electrical connector for providing a coaxial connection between a first plug connector to be inserted from a tip side and a second plug connector to be inserted from a base side, the method comprising:
holding a contact pin with a cylindrical housing by press-fitting the contact pin into the housing;
holding the housing with an outer contact by press-fitting the housing into the outer contact, wherein the outer contact includes:
   a base portion for holding the housing therein,
   a first cylindrical portion linearly extending from a tip end surface of the base portion toward the tip side and configured to contact an outer contact of the first plug connector,
   a second cylindrical portion linearly extending from the base portion toward the base side and configured to contact an outer contact of the second plug connector, and
   a through-hole that passes through the base portion, the first cylindrical portion, and the second cylindrical portion in an insertion and extraction direction of the first plug connector and the second plug connector and in which the contact pin and the housing are located; and
forming a first sealing member for sealing a gap between the contact pin and the housing and a gap between the housing and the outer contact in the second cylindrical portion of the outer contact.
(3) An electrical connector manufactured by the manufacturing method according to the above (2).

### Effect of the Disclosure

In the electrical connector of the present disclosure, the first sealing member is provided in the second cylindrical portion of the outer contact for sealing the cap between the contact pin and the housing and the gap between the housing and the outer contact. The structure of the second cylindrical portion of the outer contact is not defined by the Mini Coaxial standard and thus there is a high degree of design freedom with respect to the second cylindrical portion of the outer contact. Therefore, it is possible to improve waterproof performance of the electrical connector.

### BRIEF DESCRIPTION OF THE DRAWINGS

FIG. 1 is a schematic cross-sectional view of a conventional electrical connector.

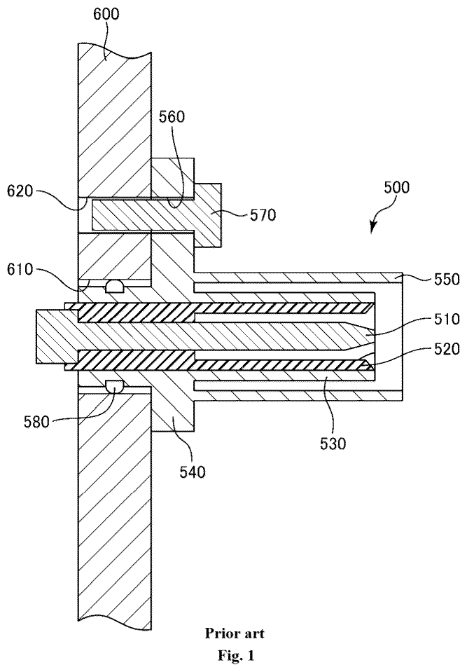

FIG. 2 is a schematic cross-sectional view of a structure of an electrical connector defined by a Mini Coaxial standard.

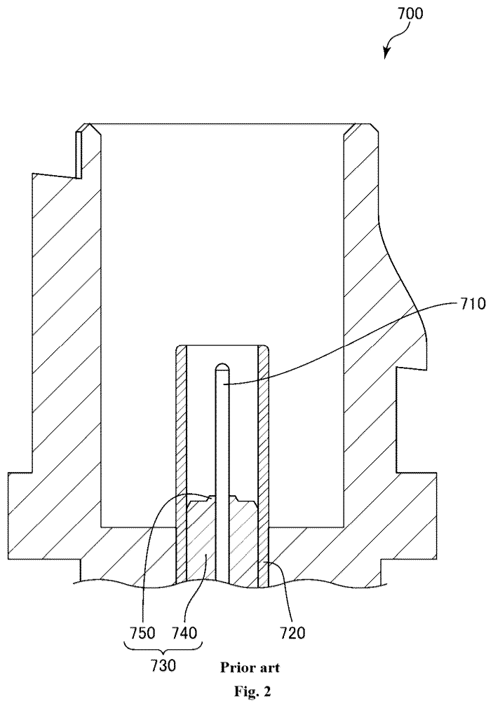

FIG. 3 is a perspective view showing an electrical connector of the present disclosure and an in-vehicle camera to which the electrical connector should be attached.

FIG. 4 is a perspective view of the electrical connector shown in FIG. 3.

FIG. 5 is another perspective view showing the electrical connector shown in FIG. 3 viewed from another angle.

FIG. 6 is a planar view of the electrical connector shown in FIG. 3 viewed from the +Z direction.

FIG. 7 is a planar view of the electrical connector shown in FIG. 3 viewed from the −Z direction.

FIG. 8 is a cross-sectional view taken along an A-A line shown in FIG. 6.

FIG. 9 is a cross-sectional view taken along a B-B line shown in FIG. 7.

FIG. 10 is an exploded perspective view of the electrical connector shown in FIG. 3.

FIG. 11 is a perspective view of a base plate shown in FIG. 10 viewed from another angle.

FIG. 12 is a perspective view of a contact pin shown in FIG. 10 viewed from another angle.

FIG. 13 is a perspective view of a housing shown in FIG. 10 viewed from another angle.

FIG. 14 is a cross-sectional perspective view of the housing shown in FIG. 10.

FIG. 15 is a cross-sectional view of an outer contact shown in FIG. 10.

FIG. 16 is a perspective view of a cover shown in FIG. 10 viewed from another angle.

FIG. 17 is a flowchart showing a method of manufacturing the electrical connector of the present disclosure.

### DETAILED DESCRIPTION

Hereinafter, description will be given to an electrical connector of the present disclosure and a method of manufacturing the electrical connector of the present disclosure based on a preferred embodiment shown in the accompanying drawings. In this regard, the drawings referenced in the following description are schematic views prepared for explaining the present disclosure. A dimension (such as a length, a width and a thickness) of each component shown in the drawings is not necessarily identical to an actual dimension. Further, the same reference numbers are used throughout the drawings to refer to the same or like elements. In the following description, a positive direction of the Z axis in each figure may be referred to as a “tip side”, a negative direction of the Z axis in each figure may be referred to as a “base side”, and the Z direction may be referred to as an “insertion and extraction direction of the plug connector”.

### <Electrical Connector>

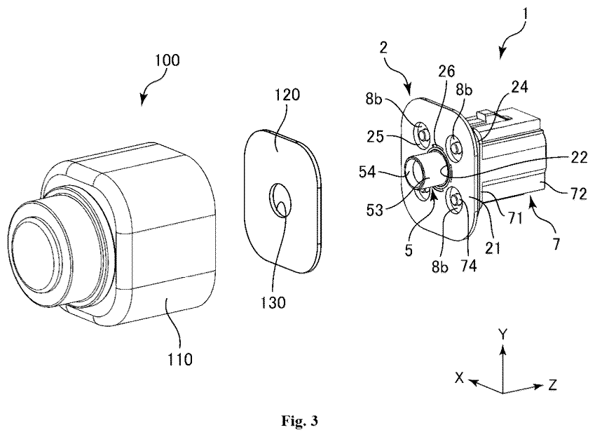

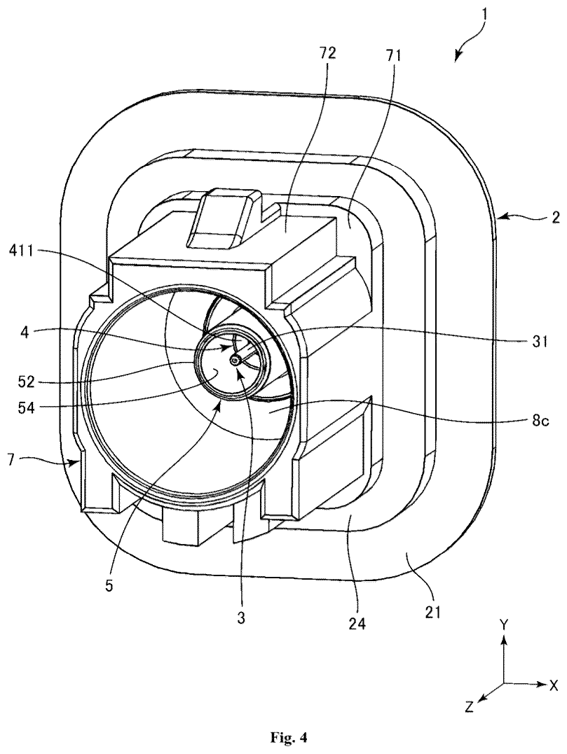

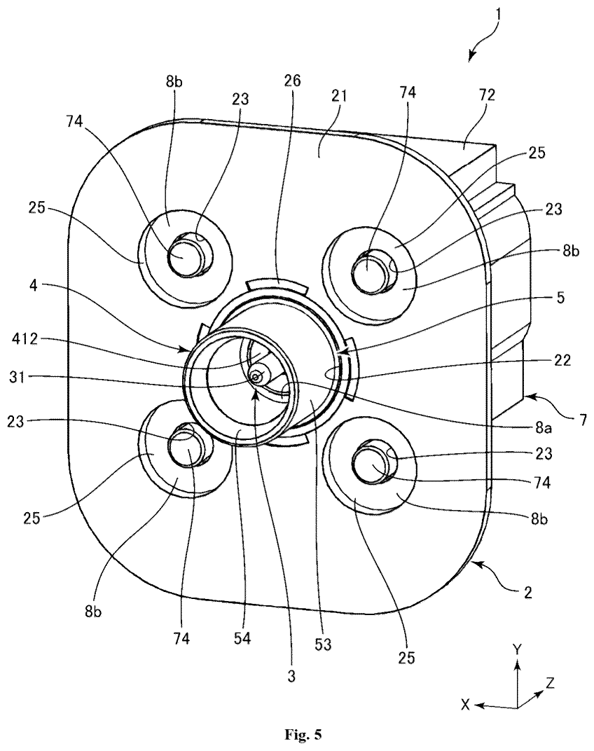

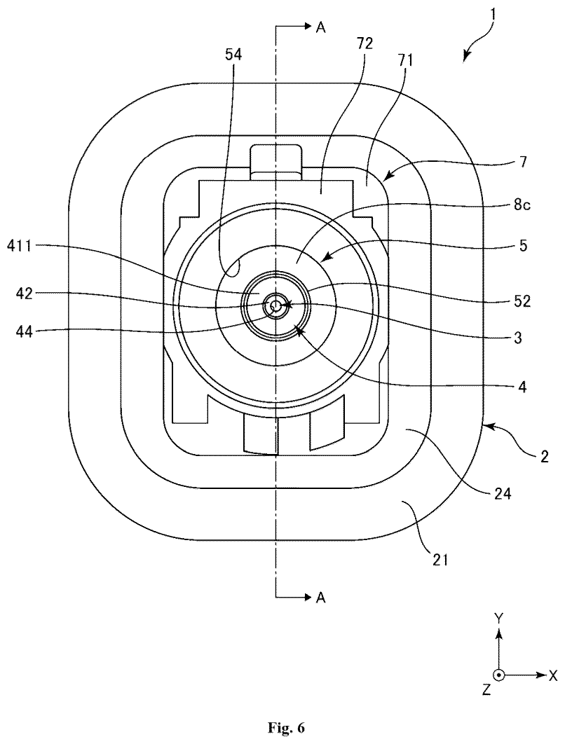

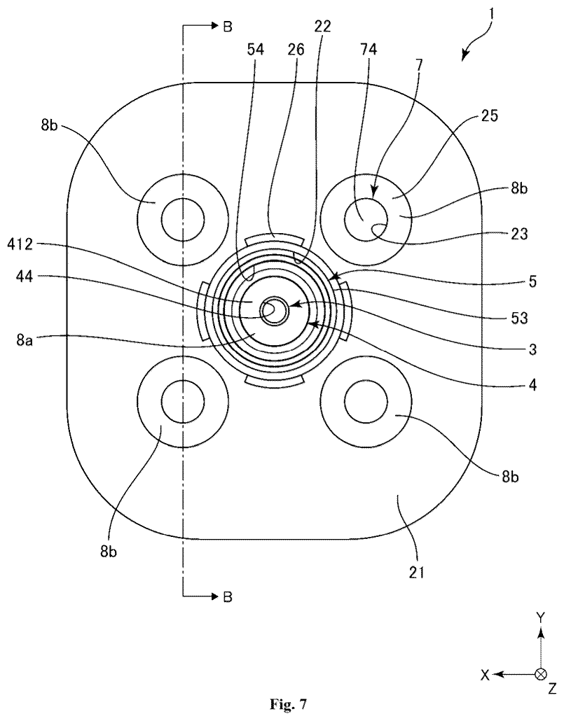

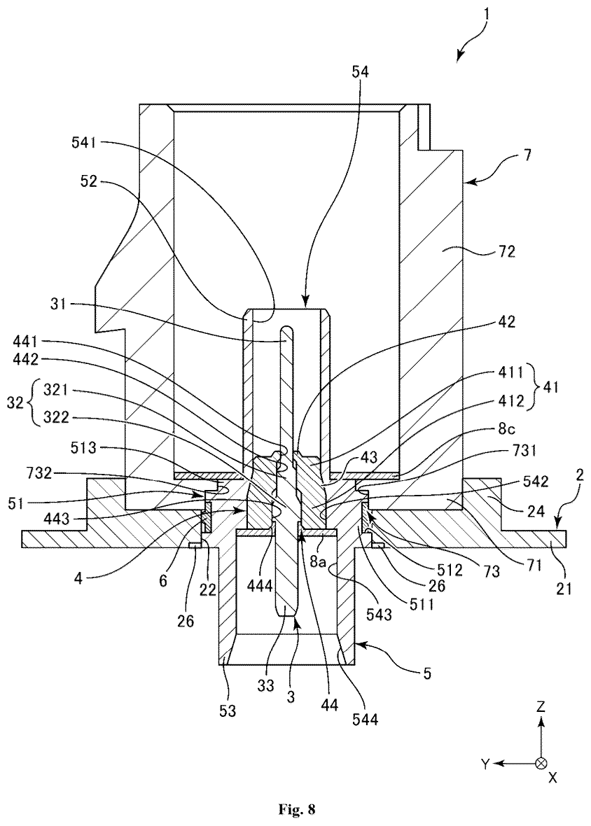

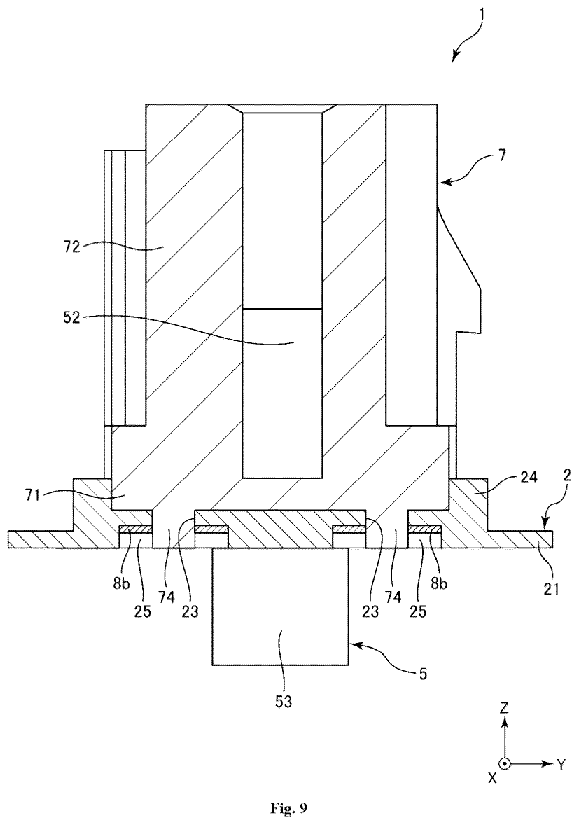

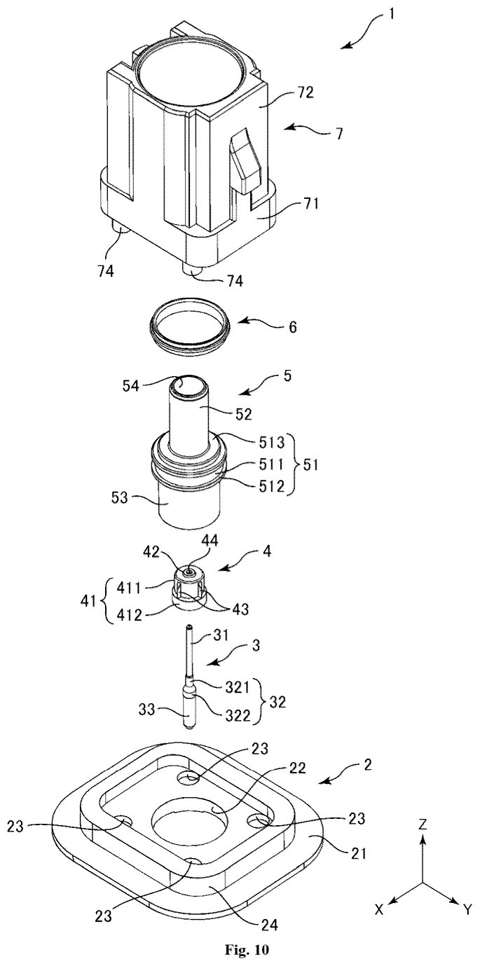

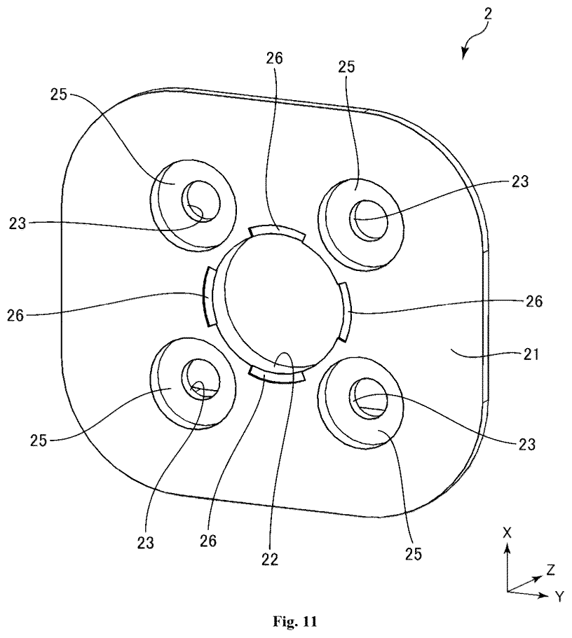

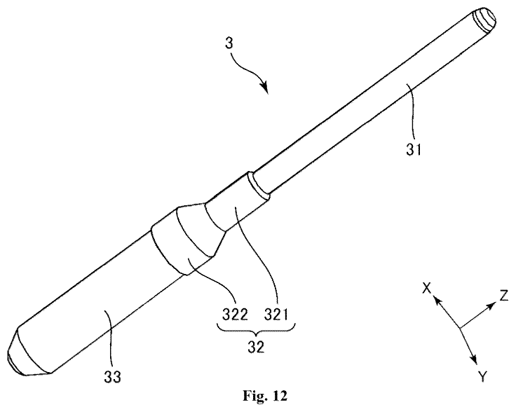

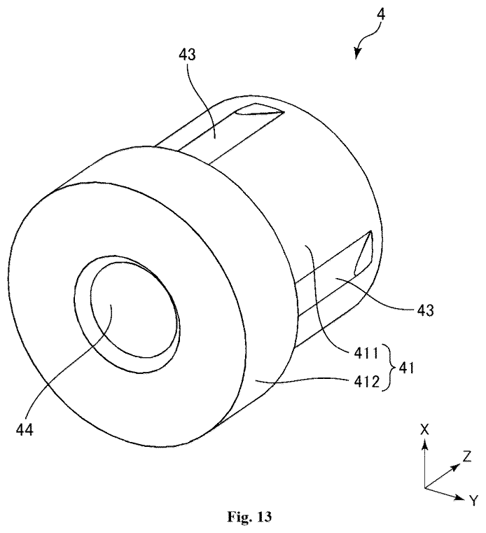

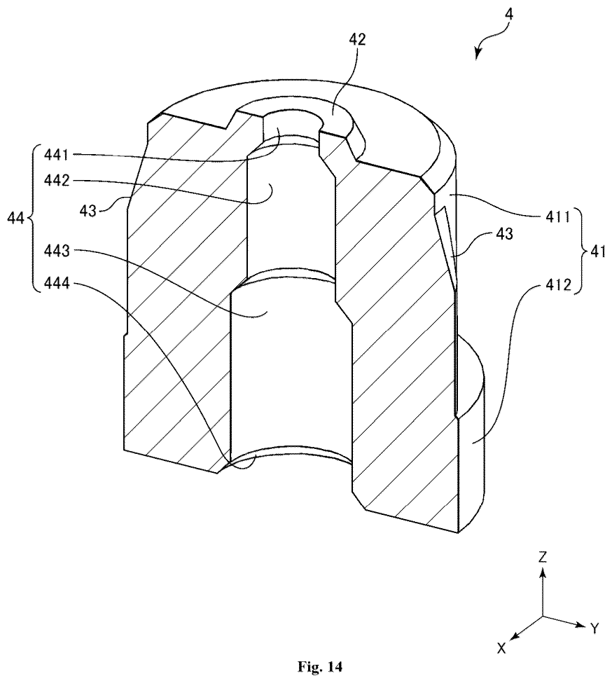

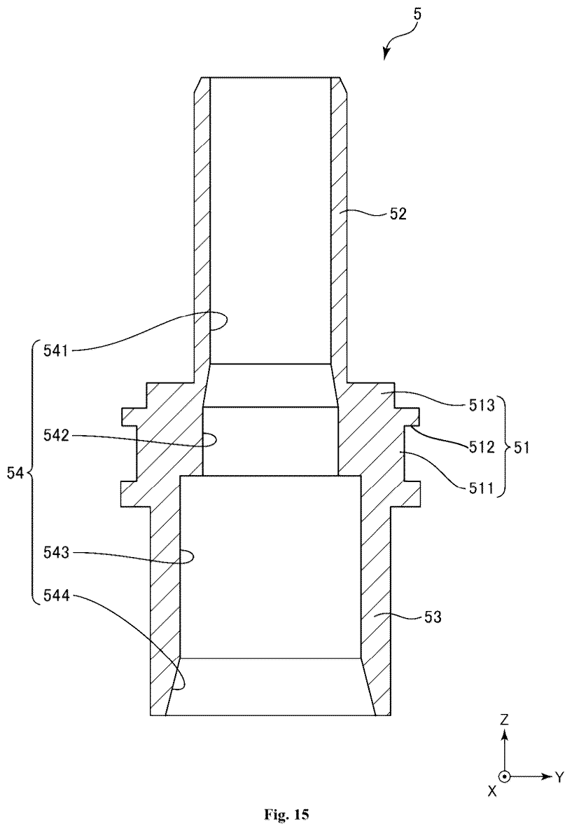

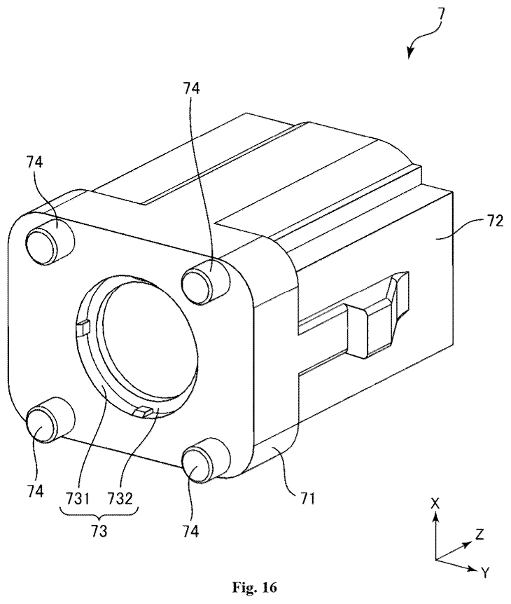

First, an electrical connector of the present disclosure will be described in detail with reference to FIGS. 3 to 16. FIG. 3 is a perspective view showing the electrical connector of the present disclosure and an in-vehicle camera to which the electrical connector should be attached. FIG. 4 is a perspective view of the electrical connector shown in FIG. 3. FIG. 5 is another perspective view showing the electrical connector shown in FIG. 3 viewed from another angle. FIG. 6 is a planar view of the electrical connector shown in FIG. 3 viewed from the +Z direction. FIG. 7 is a planar view of the electrical connector shown in FIG. 3 viewed from the −Z direction. FIG. 8 is a cross-sectional view taken along an A-A line shown in FIG. 6. FIG. 9 is a cross-sectional view taken along a B-B line shown in FIG. 7. FIG. 10 is an exploded perspective view of the electrical connector shown in FIG. 3. FIG. 11 is a perspective view of a base plate shown in FIG. 10 viewed from another angle. FIG. 12 is a perspective view of a contact pin shown in FIG. 10 viewed from another angle. FIG. 13 is a perspective view of a housing shown in FIG. 10 viewed from another angle. FIG. 14 is a cross-sectional perspective view of the housing shown in FIG. 10. FIG. 15 is a cross-sectional view of an outer contact shown in FIG. 10. FIG. 16 is a perspective view of a cover shown in FIG. 10 viewed from another angle.

As shown in FIG. 3, an electrical connector 1 of the present disclosure is configured to be mounted on a back plate 120 of a camera housing 110 of an in-vehicle camera 100 by arbitrary fixing means such as an adhesive, an adhesive tape, a retainer, and a screw. The electrical connector 1 is an adapter connector for providing a coaxial connection between a first plug connector (not shown) connected to a coaxial cable of a control device such as an ECU (Electronic Control Unit) of a vehicle and a second plug connector (not shown) connected to a coaxial cable of the in-vehicle camera 100.

One end portion of the coaxial cable of the control device is connected to the first plug connector, and the other end portion of the coaxial cable of the control device is connected to a circuit board of the control device. Similarly, one end portion of the coaxial cable of the in-vehicle camera 100 is connected to the second plug connector, and the other end portion of the coaxial cable of the in-vehicle camera 100 is connected to a circuit board of the in-vehicle camera 100. The first plug connector connected to the coaxial cable of the control device should be coupled with the electrical connector 1 from the tip side (+Z direction side). Further, the second plug connector connected to the coaxial cable of the in-vehicle camera 100 should be coupled with the electrical connector 1 from the base side (−Z direction side). Thus, the electrical connector 1 can provide the coaxial connection between the first plug connector connected to the coaxial cable of the control device and the second plug connector connected to the coaxial cable of the in-vehicle camera 100.

The electrical connector 1 shown in FIGS. 4 and 5 is an electrical connector compliant with a Mini Coaxial standard. In one embodiment, the electrical connector 1 has a width of 13.4 mm in the X direction and the Y direction and a height of 18.5 mm in the Z direction. As shown in FIGS. 8 to 10, the electrical connector 1 includes a base plate 2, a contact pin 3, an insulating housing 4 for holding the contact pin 3 therein, an outer contact 5 for holding the housing 4 therein, an annular gasket 6 attached to an outer peripheral surface of the outer contact 5, and a cover 7 for covering the outer contact 5 from an outer side. In addition, the electrical connector 1 further includes a first sealing member 8a (see FIG. 8), second sealing members 8b (see FIG. 9), and a third sealing member 8c (see FIG. 8) that respectively seal gaps between respective components of the electrical connector 1 to provide waterproof performance of the electrical connector 1. In an assembled state of the electrical connector 1, the contact pin 3, the housing 4, and the outer contact 5 are arranged coaxially with each other and constitute a coaxial structure.

As shown in FIGS. 10 and 11, the base plate 2 is a plate-like member formed from a metallic material such as aluminum. The base plate 2 includes a plate-like body portion 21, a through-hole 22 formed in the body portion 21, four fixing holes 23 formed on an outer side of the through-hole 22, a flange portion 24 linearly protruding from a tip end surface of the body portion 21 toward the tip side (the +Z direction), four circular recesses 25 formed on a base end surface of the body portion 21 so as to respectively surround the four fixing holes 23, and four crimping areas 26 formed on the base end surface of the body portion 21 so as to be adjacent to the through-hole 22.

The body portion 21 is a plate-like portion having the tip end surface and the base end surface perpendicular to the Z direction (an insertion and extraction direction of the first plug connector and the second plug connector). When the electrical connector 1 is mounted on the back plate 120 of the in-vehicle camera 100, the base end surface of the body portion 21 is fixed on the back plate 120 by arbitrary fixing means such as an adhesive, an adhesive tape, a retainer, and a screw. When the electrical connector 1 is mounted on the back plate 120 of the in-vehicle camera 100, the outer contact 5 extends into the camera housing 110 through a through-hole 130 (see FIG. 3) formed in the back plate 120. The through-hole 22 is a circular through-hole formed so as to linearly pass through the body portion 21 in the Z direction. As shown in FIG. 8, the outer contact 5 is held by the base plate 2 in a state in which the outer contact 5 is passed through the through-hole 22.

Referring back to FIGS. 10 and 11, the four fixing holes 23 are arranged on the outer side of the through-hole 22 while being spaced apart from each other. The four fixing holes 23 are circular holes formed in the body portion 21 so as to linearly pass through the body portion 21 in the Z direction. The four fixing holes 23 are formed on the outer side of the through-hole 22 at equal angular intervals of 90 degrees. As shown in FIG. 5, four bosses 74 of the cover 7 respectively pass through the four fixing holes 23 and are bonded to the body portion 21 with a thermocompression process, thereby holding the cover 7 by the base plate 2.

Referring back to FIG. 10, the flange portion 24 is a rectangular annular portion that linearly protrudes from the tip end surface of the body portion 21 toward the tip side. The flange portion 24 is formed so as to surround the through-hole 22 and the four fixing holes 23 from the outer side. As shown in FIG. 8, when the cover 7 is fitted into the flange portion 24, the cover 7 is supported from the outer side, thereby preventing swinging and rotation of the cover 7 on the base plate 2.

Referring back to FIG. 11, the four circular recesses 25 are formed on the base end surface of the body portion 21 so as to respectively surround the four fixing holes 23. Thus, the four fixing holes 23 respectively communicate between bottom surfaces (surfaces facing the base side) of the four circular recesses 25 and the tip end surface of the body portion 21. The four crimping areas 26 are arc-shaped recesses formed on the base end surface of the body portion 21 so as to be spaced apart from each other and arranged at equal angular intervals of 90 degrees while being adjacent to the through-hole 22. Each of the four crimping areas 26 extends in an arcuate shape with a constant width and is adjacent to the through-hole 22. As described below, by crimping the four crimping areas 26 toward the inner side so as to press the outer contact 5 from the outer side in the state in which the outer contact 5 is passed through the through-hole 22, the outer contact 5 is fixedly held by the base plate 2.

Referring back to FIG. 10, the contact pin 3 functions as an electrical path between a contact pin of the first plug connector to be inserted into the electrical connector 1 from the tip side and a contact pin of the second plug connector to be inserted into the electrical connector 1 from the base side. The contact pin 3 is a rod-shaped member formed from a metallic material such as brass. As shown in FIG. 12, the contact pin 3 includes a first contact portion 31 located on the tip side and configured to contact the contact pin of the first plug connector, a press-fitted portion 32 extending from the first contact portion 31 toward the base side and press-fitted into the housing 4, and a second contact portion 33 linearly extending from the press-fitted portion 32 toward the base side and configured to contact the contact pin of the second plug connector. The first contact portion 31, the press-fitted portion 32, and the second contact portion 33 are formed integrally with each other so as to be concentric with each other.

The first contact portion 31 is a columnar portion linearly extending in the Z direction. As shown in FIG. 8, in the assembled state of the electrical connector 1, the first contact portion 31 protrudes from the housing 4 toward the tip side so as to be exposed in the outer contact 5. Thus, the first contact portion 31 can contact the contact pin of the first plug connector to be inserted into the electrical connector 1 from the tip side. Referring back to FIG. 12, the press-fitted portion 32 is a portion extending from the first contact portion 31 toward the base side. The press-fitted portion 32 includes a small diameter portion 321 extending from the first contact portion 31 toward the base side and a large diameter portion 322 linearly extending from the small diameter portion 321 toward the base side.

The small diameter portion 321 is a columnar portion linearly extending from a base end portion of the first contact portion 31 toward the base side. A diameter of the small diameter portion 321 is larger than a diameter of the first contact portion 31. The large diameter portion 322 is a columnar portion linearly extending from a base end portion of the small diameter portion 321 toward the base side. A diameter of the large diameter portion 322 is larger than the diameter of the small diameter portion 321. Further, a connection portion between the small diameter portion 321 and the large diameter portion 322 is a tapered surface whose diameter increases from the tip side toward the base side. The second contact portion 33 is a columnar portion linearly extending from a base end portion of the large diameter portion 322 toward the base side. A diameter of the second contact portion 33 is smaller than the diameter of the large diameter portion 322 and larger than the diameter of the small diameter portion 321. As shown in FIG. 8, in the assembled state of the electrical connector 1, the second contact portion 33 protrudes from the housing 4 toward the base side so as to be exposed in the outer contact 5. Thus, the second contact portion 33 can contact the contact pin of the second plug connector to be inserted into electrical connector 1 from the base side.

Referring back to FIG. 10, the housing 4 is a cylindrical member formed from an elastic insulating material such as liquid crystal polymer and nylon. The contact pin 3 is press-fitted into the housing 4, and thereby the contact pin 3 is fixedly held by the housing 4. As shown in FIGS. 13 and 14, the housing 4 includes a cylindrical holding portion 41 for holding the press-fitted portion 32 of the contact pin 3 therein, a cylindrical protruding portion 42 protruding from a tip end surface of the holding portion 41 toward the tip side, four ribs 43 formed on an outer peripheral surface of the holding portion 41, and a through-hole 44 that linearly passes through the holding portion 41 and the protruding portion 42 in the Z direction and through which the contact pin 3 is passed.

The holding portion 41 is a cylindrical portion into which the press-fitted portion 32 of the contact pin 3 is press-fitted, thereby holding the press-fitted portion 32 from the outer side. The holding portion 41 includes a cylindrical small diameter portion 411 located on the tip side and linearly extending in the Z direction and a cylindrical large diameter portion 412 linearly extending from a base end portion of the small diameter portion 411 toward the base side. A tip end surface of the small diameter portion 411 and a base end surface of the large diameter portion 412 are flat surfaces perpendicular to the Z direction. Further, the small diameter portion 411 and the large diameter portion 412 are formed integrally with each other so as to be concentric with each other. An outer diameter of the large diameter portion 412 is larger than an outer diameter of the small diameter portion 411.

The protruding portion 42 is a cylindrical portion formed on the tip end surface of the small diameter portion 411 so as to be concentric with the small diameter portion 411. A tip end surface of the protruding portion 42 is a flat surface perpendicular to the Z direction. Further, an outer diameter of the protruding portion 42 is smaller than the outer diameter of the small diameter portion 411 and gradually increases from the tip side toward the base side. As shown in FIG. 8, the protruding portion 42 protrudes from the tip end surface of the small diameter portion 411 toward the tip side and covers a base side portion of the first contact portion 31 of the contact pin 3 from the outer side.

Referring back to FIG. 13, the four ribs 43 are protruding portions formed on an outer peripheral surface of the small diameter portion 411 at equal angular intervals and linearly extending in the Z direction. The through-hole 44 is a circular hole formed so as to linearly pass through center portions of the holding portion 41 and the protruding portion 42 in the Z direction. As shown in FIG. 14, the through-hole 44 includes a first section 441, a second section 442, a third section 443, and a fourth section 444. The first section 441, the second section 442, the third section 443, and the fourth section 444 are arranged in the order of naming from the tip side so as to be concentric with each other.

The first section 441 is a columnar space passing through the protruding portion 42 in the Z direction and communicating with the outside. The first section 441 is defined by an inner peripheral surface of the protruding portion 42 and has a constant diameter along the Z direction. Further, a diameter of the first section 441 is substantially equal to the diameter of the first contact portion 31 of the contact pin 3. The second section 442 is a columnar space located on the base side of the first section 441 and communicating with the first section 441. The second section 442 is defined by an inner peripheral surface of the small diameter portion 411 and has a constant diameter along the Z direction. A diameter of the second section 442 is larger than the diameter of the first section 441 and is substantially equal to the diameter of the small diameter portion 321 of the contact pin 3. A connection portion between the first section 441 and the second section 442 is a tapered surface whose diameter gradually increases from the tip side toward the base side.

The third section 443 is a columnar space located on the base side of the second section 442 and communicating with the second section 442. The third section 443 is defined by the inner peripheral surface of the small diameter portion 411 and an inner peripheral surface of the large diameter portion 412 and has a constant diameter along the Z direction. A diameter of the third section 443 is larger than the diameter of the second section 442 and is substantially equal to the diameter of the large diameter portion 322 of the contact pin 3. Further, a connection portion between the second section 442 and the third section 443 is a tapered surface whose diameter gradually increases from the tip side toward the base side. The fourth section 444 is a tapered space located on the base side of the third section 443 and communicating with the third section 443. The fourth section 444 passes through the base end surface of the large diameter portion 412 in the Z direction and communicates with the outside. The fourth section 444 has a tapered shape whose diameter gradually increases from the tip side toward the base side. Further, a maximum value of a diameter of the fourth section 444, that is, the diameter of the fourth section 444 on the base end surface of the large diameter portion 412 is larger than the diameter of the large diameter portion 322.

As shown in FIG. 8, the contact pin 3 passes through the through-hole 44 of the housing 4, and the press-fitted portion 32 of the contact pin 3 is press-fitted into the holding portion 41 of the housing 4. As a result, the contact pin 3 is held by the housing 4. In this state, the protruding portion 42 of the housing 4 covers the base side portion of the first contact portion 31 from the outer side. Further, the first contact portion 31 of the contact pin 3 passes through the first section 441 and protrudes toward the tip side. The second contact portion 33 of the contact pin 3 protrudes from the fourth section 444 toward the base side.

In a state in which the contact pin 3 is held by the housing 4, the small diameter portion 321 of the contact pin 3 is press-fitted into the second section 442, and the large diameter portion 322 of the contact pin 3 is press-fitted into the third section 443. Due to friction between the small diameter portion 321 and the inner peripheral surface of the small diameter portion 411, which defines the second section 442, and friction between the large diameter portion 322 and the inner peripheral surfaces of the small diameter portion 411 and the large diameter portion 412, which define the third section 443, it is possible to prevent the contact pin 3 from being removed from the housing 4.

In this regard, the contact pin 3 is press-fitted into the through-hole 44 of the housing 4. On the other hand, the contact pin 3 is formed from the metallic material and the housing 4 is formed from the elastic insulating material. When press-fitting is performed between such two parts formed from such dissimilar materials having different hardnesses, a slight gap is generated between the two parts. Thus, there is a gap between the contact pin 3 and the through-hole 44 of the housing 4.

Referring back to FIG. 10, the outer contact 5 is a cylindrical member formed from a metallic material such as a zinc alloy. The outer contact 5 functions as an outer conductor layer for holding the contact pin 3 and the housing 4 therein. As shown in FIGS. 10 and 15, the outer contact 5 includes a cylindrical base portion 51 for holding the holding portion 41 of the housing 4 therein, a first cylindrical portion 52 extending from the base portion 51 toward the tip side, a second cylindrical portion 53 extending from the base portion 51 toward the base side, and a through-hole 54 that linearly passes through the base portion 51, the first cylindrical portion 52, and the second cylindrical portion 53 in the Z direction and in which the contact pin 3 and the housing 4 are located. Further, the base portion 51, the first cylindrical portion 52, and the second cylindrical portion 53 are formed integrally with each other so as to be concentric with each other.

The base portion 51 is a cylindrical portion that passes through the through-hole 22 of the base plate 2. The base portion 51 includes a cylindrical body portion 511, a holding groove 512 formed on an outer peripheral surface of the body portion 511 and a fitting protrusion 513 protruding from a tip end surface of the body portion 511 toward the tip side. The body portion 511 is a cylindrical portion linearly extending in the Z direction with a constant diameter. The tip end surface and a base end surface of the body portion 511 are flat surfaces perpendicular to the Z direction. The holding groove 512 is a recess formed so as to go around the outer peripheral surface of the body portion 511 in its circumferential direction. The gasket 6, which is formed from an elastic material such as silicone rubber, is mounted in the holding groove 512. As shown in FIG. 8, when the outer contact 5 passes through the through-hole 22 of the base plate 2, the body portion 511 is located in the through-hole 22. In this state, the gasket 6 mounted in the holding groove 512 contacts an inner peripheral surface of the through-hole 22, thereby liquid-tightly sealing a gap between the outer contact 5 and the through-hole 22.

Referring back to FIGS. 10 and 15, the fitting protrusion 513 is an annular portion extending from the tip end surface of the body portion 511 toward the tip side. The fitting protrusion 513 is formed on the tip end surface of the body portion 511 so as to surround the first cylindrical portion 52. A tip end surface of the fitting protrusion 513 is a flat surface perpendicular to the Z direction. Further, an outer diameter of the fitting protrusion 513 is smaller than an outer diameter of the body portion 511.

The first cylindrical portion 52 is a cylindrical portion linearly extending from the tip end surface of the body portion 511 of the base portion 51 toward the tip side. An outer diameter of the first cylindrical portion 52 is smaller than the outer diameter of the body portion 511 and the outer diameter of the fitting protrusion 513 of the base portion 51. The second cylindrical portion 53 is a cylindrical portion linearly extending from the base end surface of the body portion 511 of the base portion 51 toward the base side. An outer diameter of the second cylindrical portion 53 is larger than the outer diameter of the first cylindrical portion 52 and smaller than an outer diameter of the base portion 51.

The through-hole 54 is a circular hole linearly passing through the base portion 51, the first cylindrical portion 52, and the second cylindrical portion 53 in the Z direction. The through-hole 54 includes a first section 541, a second section 542, a third section 543, and a fourth section 544. The first section 541, the second section 542, the third section 543, and the fourth section 544 are arranged in the order of naming from the tip side so as to be concentric with each other.

The first section 541 is a columnar space linearly passing through the first cylindrical portion 52 in the Z direction and communicating with the outside. The first section 541 is defined by an inner peripheral surface of the first cylindrical portion 52 and has a constant diameter along the Z direction. Further, a diameter of the first section 541 is slightly larger than the outer diameter of the small diameter portion 411 of the housing 4. Thus, in a state in which the housing 4 is held by the outer contact 5, there is a gap between the inner peripheral surface of the first cylindrical portion 52 defining the first section 541 and the small diameter portion 411.

The second section 542 is a columnar space located on the base side of the first section 541 and communicating with the first section 541. Further, the second section 542 is located inside the body portion 511. The second section 542 is defined by an inner peripheral surface of the body portion 511 and has a constant diameter along the Z direction. A diameter of the second section 542 is substantially equal to the outer diameter of the large diameter portion 412 of the housing 4. Further, a connection portion between the first section 541 and the second section 542 is a tapered surface whose diameter gradually increases from the tip side toward the base side. The third section 543 is a columnar space located on the base side of the second section 542 and communicating with the second section 542. The third section 543 is defined by the inner peripheral surface of the body portion 511 and an inner peripheral surface of the second cylindrical portion 53. The third section 543 has a constant diameter along the Z direction. A diameter of the third section 543 is larger than the diameter of the second section 542 and the outer diameter of the large diameter portion 412. Further, a connection portion between the second section 542 and the third section 543 is a flat surface perpendicular to the Z direction. The fourth section 544 is a tapered space located on the base side of the third section 543 and communicating with the third section 543.

The housing 4 is inserted into the through-hole 54 of the outer contact 5 from the base side, and the large diameter portion 412 of the housing 4 is press-fitted into the second section 542. As a result, the housing 4 is held by the outer contact 5. As shown in FIG. 8, in the state in which the housing 4 is held by the outer contact 5, a tip side portion of the small diameter portion 411 of the housing 4 is located in the first section 541, and the large diameter portion 412 of the housing 4 is located in the second section 542. In this state, the four ribs 43 of the housing 4 abut against the connection portion between the first section 541 and the second section 542, and the large diameter portion 412 contacts the second section 442. Due to friction between the large diameter portion 412 and the inner peripheral surface of the body portion 511 defining the second section 542, the housing 4 is prevented from being removed from the outer contact 5. Further, in this state, the base end surface of the large diameter portion 412 of the housing 4 and the connection portion between the second section 542 and the third section 543 are located on the substantially same plane.

In this regard, the large diameter portion 412 of the housing 4 is press-fitted into the second section 542. On the other hand, the housing 4 is formed from the elastic insulating material, and the outer contact 5 is formed from the metallic material. As described above, when press-fitting is performed between two parts formed from dissimilar materials having different hardnesses, a slight gap is generated between the two parts. Thus, there is a gap between the large diameter portion 412 and the inner surface of the body portion 511 defining the second section 542. Further, in this state, the first contact portion 31 of the contact pin 3 is exposed in the first cylindrical portion 52 while being spaced apart from the first cylindrical portion 52. In addition, the second contact portion 33 of the contact pin 3 is exposed in the second cylindrical portion 53 while being spaced apart from the second cylindrical portion 53.

In the state in which the contact pin 3 and the housing 4 are held by the outer contact 5, the outer contact 5 passes through the through-hole 22 of the base plate 2 from the base side. Subsequently, the crimping areas 26 of the base plate 2 are crimped toward the inner side, and thereby the outer contact 5 is fixedly held by the base plate 2. In this state, the gasket 6 mounted in the holding groove 512 of the outer contact 5 liquid-tightly seals the gap between the base portion 51 of the outer contact 5 and the through-hole 22.

Referring back to FIG. 10, the cover 7 is a cylindrical member that covers the first cylindrical portion 52 of the outer contact 5 from the outer side while being spaced apart from the first cylindrical portion 52. The cover 7 is formed from a resin material such as nylon or polyamide resin. The cover 7 is attached to the base plate 2 to guide coupling of the first plug connector to the electrical connector 1 from the tip side. As shown in FIGS. 10 and 16, the cover 7 includes a plate-like base portion 71, a cylindrical portion 72 extending from a tip end surface of the base portion 71 toward the tip side, a through-hole 73 linearly passing through the base portion 71 in the Z direction, and the four bosses 74 protruding from a base end surface of the base portion 71 toward the base side.

The base portion 71 is a plate-like portion having a planar shape corresponding to an inner space of the flange portion 24 of the base plate 2. In a state in which the cover 7 is attached to the base plate 2, the base portion 71 is held within the inner space of the flange portion 24. The tip end surface and the base end surface of the base portion 71 are flat surfaces perpendicular to the Z direction. The cylindrical portion 72 is a rectangular cylindrical portion linearly extending from the tip end surface of the base portion 71 toward the tip side. As shown in FIG. 8, in the assembled state of the electrical connector 1, the cylindrical portion 72 covers the first cylindrical portion 52 of the outer contact 5 from the outer side while being spaced apart from the first cylindrical portion 52. When the first plug connector is coupled with the electrical connector 1 from the tip side, the first plug connector slides on an inner peripheral surface of the cylindrical portion 72, thereby guiding the coupling of the first plug connector to the electrical connector 1.

In a state in which the first plug connector is coupled with the electrical connector 1, the cylindrical portion 72 supports the first plug connector from the outer side. Thus, even if a twisting operation, a tilting operation, or vibration is applied to the first plug connector, it is possible to prevent significant displacement or vibration of the first plug connector. Further, the cover 7 is a separate component from the base plate 2 and is formed from the resin material that is more flexible than the metallic material. Thus, even if the twisting operation, the tilting operation, or the vibration is applied to the first plug connector, the cylindrical portion 72 can elastically deform to absorb displacement or vibration of the first plug connector. As a result, it is possible to prevent strong loads from being applied to the base plate 2 and the outer contact 5. Thus, it is possible to prevent lifting of the base plate 2 from the back plate 120 of the in-vehicle camera 100 and deformation of the outer contact 5, thereby improving connection reliability of the electrical connector 1 and extending product lifetime of the electrical connector 1.

Referring back to FIG. 16, the through-hole 73 is a circular hole formed so as to linearly pass through a central portion of the base portion 71 in the Z direction. The through-hole 73 includes a straight portion 731 extending in the Z direction and an annular abutting portion 732 formed so as to protrude from an inner peripheral surface of the straight portion 731 toward the inner side. The straight portion 731 is a circular hole extending straight in the Z direction with a constant diameter. A diameter of the straight portion 731 is substantially equal to the outer diameter of the body portion 511 of the outer contact 5. The abutting portion 732 is an annular portion protruding from a tip side portion of the inner peripheral surface of the straight portion 731 toward the inner side. An inner diameter of the abutting portion 732 is smaller than the outer diameter of the body portion 511 and substantially equal to the outer diameter of the fitting protrusion 513 of the outer contact 5. Further, a tip end surface of the abutting portion 732 is continuous with the tip end surface of the base portion 71.

As shown in FIG. 8, in the assembled state of the electrical connector 1, the body portion 511 of the outer contact 5 is fitted into the straight portion 731 and abuts against the abutting portion 732 from the base side. Further, the fitting protrusion 513 of the outer contact 5 is fitted into the abutting portion 732. Furthermore, in this state, the tip end surfaces of the base portion 71 and the abutting portion 732 of the cover 7 and the tip end surface of the fitting protrusion 513 of the outer contact 5 are located on the substantially same plane.

Referring back to FIG. 16, the four bosses 74 are columnar portions that are formed on the base end surface of the base portion 71 and at positions respectively corresponding to the four fixing holes 23 of the base plate 2. As shown in FIG. 9, when the cover 7 is attached to the base plate 2, the four bosses 74 are formed so as to respectively pass through the four fixing holes 23 and protrude toward the base side. In the state in which the cover 7 is attached to the base plate 2, the thermocompression process is applied to the four bosses 74. In this thermocompression process, portions of the bosses 74 protruding from the body portion 21 of the base plate 2 toward the base side are crushed, thereby preventing the cover 7 from being removed from the base plate 2. In this regard, the four bosses 74 are formed from the resin material, and the base plate 2 is formed from the metallic material. When the thermocompression process is applied between two parts formed from such dissimilar materials, a slight gap is generated between the two parts. Thus, even after the thermocompression process is applied to each boss 74 to attach the cover 7 to the base plate 2, there is a gap between each boss 74 and the corresponding fixing hole 23.

Referring back to FIGS. 8 and 9, the first sealing member 8a, the second sealing members 8b, and the third sealing member 8c are members that respectively seal the gaps between the respective components of the electrical connector 1 in a liquid-tight manner. Each of the first sealing member 8a, the second sealing members 8b, and the third sealing member 8c is formed by applying a curable material such as a thermosetting resin and a photocurable resin onto a predetermined location, and then performing a curing process such as heating and light irradiation on the curable material to cure the curable material.

As shown in FIG. 8, the first sealing member 8a is provided in the second cylindrical portion 53 of the outer contact 5 for liquid-tightly sealing the gap between the large diameter portion 322 of the contact pin 3 and the third section 443 of the through-hole 44 of the housing 4 and the gap between the large diameter portion 412 of the housing 4 and the second section 542 of the through-hole 54 of the outer contact 5. The first sealing member 8a is formed in the second cylindrical portion 53 by the following procedure. A sufficient amount of curable material is applied onto the base end surface of the large diameter portion 412 and the connection portion between the second section 542 and the third section 543, which are located in the second cylindrical portion 53, from the base side to fill the curable material into the gap between the large diameter portion 322 and the third section 443 and the gap between the large diameter portion 412 and the second section 542. Subsequently, by performing the curing process on the applied curable material and curing the applied curable material, the first sealing member 8a is formed so as to close the gap between the large diameter portion 322 and the third section 443 and the gap between the large diameter portion 412 and the second section 542. The first sealing member 8a liquid-tightly seals the gap between the contact pin 3 and the housing 4 and the gap between the housing 4 and the outer contact 5 in the second cylindrical portion 53. As a result, it is possible to prevent the ingress of water, dust, vapor, and the like from the tip side to the base side or from the base side to the tip side in the outer contact 5, thereby improving the waterproof performance of the electrical connector 1.

As described in the background art section, the Mini Coaxial standard strictly defines a structure of a tip side portion of the electrical connector 1 which should be coupled with the first plug connector connected to the coaxial cable of the control device is coupled, that is, a structure inside the first cylindrical portion 52 of the outer contact 5 and thus there is little design freedom for the structure. Thus, as long as the electrical connector 1 complies with the Mini Coaxial standard, it is not possible to provide an additional sealing member such as the first sealing member 8a in the first cylindrical portion 52. On the other hand, in the electrical connector 1 of the present disclosure, the first sealing member 8a is provided on a base side portion of the electrical connector 1 for which the Mini Coaxial standard does not define any requirements and thus there is high design freedom. Namely, the first sealing member 8a is provided in the second cylindrical portion 53 of the outer contact 5. With this configuration, it is possible to allow the electrical connector 1 to satisfy the Mini Coaxial standard as well as improve the waterproof performance of the electrical connector 1.

As shown in FIG. 9, the second sealing member 8b is provided in each of the four circular recesses 25 formed on the base end surface of the body portion 21 of the base plate 2 for liquid-tightly sealing the gap between each boss 74 of the cover 7 and the corresponding circular recess 25. In each figure, the portions of the four bosses 74 protruding from the body portion 21 toward the base side are not crushed. However, it should be noted that when the cover 7 is attached to the base plate 2, the portions of the four bosses 74 protruding from the body portion 21 toward the base side are crushed by the thermocompression process.

The second sealing member 8b is formed in each of the four circular recesses 25 by the following procedure. In a state in which the thermocompression process is applied to the four bosses 74 of the cover 7 and thus the cover 7 is attached to the base plate 2, the curable material is applied onto each of the bottom surfaces of the four circular recesses 25 from the base side to fill the curable material into the gap between the fixing hole 23 in each circular recess 25 and the corresponding boss 74. Subsequently, by performing the curing process on the applied curable material and curing the applied curable material, the second sealing member 8b is formed in each of the four circular recesses 25 so as to close the gap between the fixing hole 23 in each circular recess 25 and the corresponding boss 74. The gaps between the base plate 2 and the cover 7 are liquid-tightly sealed by the second sealing members 8b. As a result, it is possible to prevent the ingress of water, dust, vapor, and the like from the tip side to the base side or from the base side to the tip side via the base plate 2, thereby improving the waterproof performance of the electrical connector 1.

Referring back to FIG. 8, the third sealing member 8c is provided in the cylindrical portion 72 of the cover 7 for liquid-tightly sealing a gap between the fitting protrusion 513 of the base portion 51 of the outer contact 5 and the abutting portion 732 of the through-hole 73 of the cover 7. The third sealing member 8c is formed in the cylindrical portion 72 by the following procedure. A sufficient amount of curable material is applied onto the tip end surface of the fitting protrusion 513 of the outer contact 5 and the tip end surfaces of the base portion 71 and the abutting portion 732 of the cover 7 from the tip side to fill the curable material into the gap between the fitting protrusion 513 and the abutting portion 732. Subsequently, by performing the curing process on the applied curable material and curing the applied curable material, the third sealing member 8c is formed so as to close the gap between the fitting protrusion 513 and the abutting portion 732. The gap between the outer contact 5 and the cover 7 is liquid-tightly sealed in the cylindrical portion 72 by the third sealing member 8c. As a result, it is possible to prevent the ingress of water, dust, vapor, and the like from the tip side to the base side or from the base side to the tip side in the cover 7, thereby improving the waterproof performance of the electrical connector 1.

Further, as described above, the gasket 6 liquid-tightly seals the gap between the base portion 51 of the outer contact 5 and the through-hole 22 of the base plate 2. Thus, in the electrical connector 1 of the present disclosure, all of the gaps between the respective components of the electrical connector 1 are liquid-tightly sealed by the gasket 6, the first sealing member 8a, the second sealing members 8b, and the third sealing member 8c. With this configuration, it is possible to prevent the ingress of water, dust, vapor, and the like from the tip side to the base side or from the base side to the tip side, thereby improving the waterproof performance of the electrical connector 1.

Further, in the electrical connector 1 of the present disclosure, the cover 7 is formed from the resin material that is more flexible than the metallic material. Furthermore, the cover 7 is formed separately from the base plate 2. Thus, even if the twisting operation, the tilting operation, or the vibration is applied to the first plug connector in the state in which the first plug connector is coupled with the electrical connector 1, the cover 7 can elastically deform to absorb the displacement or the vibration of the first plug connector. As a result, it is possible to prevent the strong loads from being applied to the base plate 2 and the outer contact 5. Thus, it is possible to prevent the lifting of the base plate 2 from the back plate 120 of the in-vehicle camera 100 and the deformation of the outer contact 5, thereby improving the connection reliability of the electrical connector 1 and extending the product lifetime of the electrical connector 1.

### <Method of Manufacturing Electrical Connector>

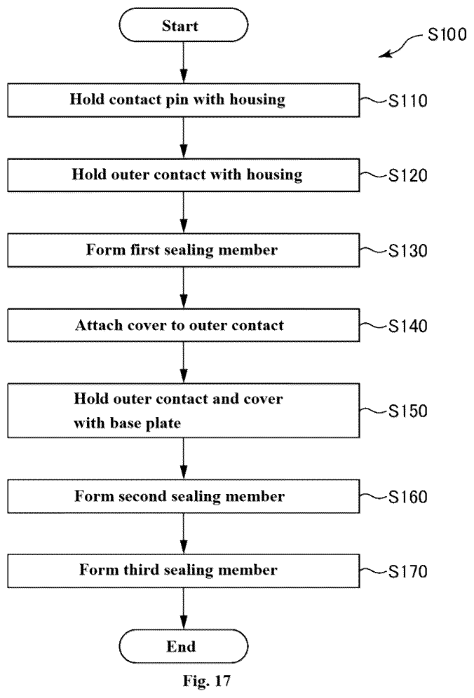

Next, detailed description will be given to a method of manufacturing the electrical connector 1 described above. FIG. 17 is a flowchart showing the method of manufacturing the electrical connector of the present disclosure.

A manufacturing method S100 of the electrical connector 1 of the present disclosure is performed by a manufacturing machine that automatically manufactures the electrical connector 1 or by an operator who manufactures the electrical connector 1 manually. First, at a step S110, the contact pin 3 is held by the housing 4. Specifically, the contact pin 3 is press-fitted into the through-hole 44 of the housing 4 from the base side. The press-fitting of the contact pin 3 into the through-hole 44 is completed when the small diameter portion 321 of the contact pin 3 is press-fitted into the second section 442 of the housing 4 and the large diameter portion 322 of the contact pin 3 is press-fitted into the third section 443 of the housing 4. As shown in FIG. 8, in this state, the first contact portion 31 of the contact pin 3 protrudes from the holding portion 41 of the housing 4 toward the tip side, and the second contact portion 33 of the contact pin 3 protrudes from the holding portion 41 toward the base side. Further, the protruding portion 42 of the housing 4 covers the base side portion of the first contact portion 31 from the outer side.

Referring back to FIG. 17, at a step S120, the housing 4 holding the contact pin 3 therein is held by the outer contact 5. Specifically, the housing 4 is press-fitted into the through-hole 54 of the outer contact 5 from the base side. The press-fitting of the housing 4 into the through-hole 54 is completed when the four ribs 43 of the housing 4 abut against the connection portion between the first section 541 and the second section 542 of the outer contact 5 from the base side. As shown in FIG. 8, in this state, the base end surface of the large diameter portion 412 of the housing 4 and the connection portion between the second section 542 and the third section 543 of the outer contact 5 are located on the substantially same plane.

Referring back to FIG. 17, at a step S130, the first sealing member 8a is formed in the second cylindrical portion 53 of the outer contact 5. Specifically, the sufficient amount of curable material is applied from the base side onto the base end surface of the large diameter portion 412 of the housing 4 and the connection portion between the second section 542 and the third section 543 of the outer contact 5 in the second cylindrical portion 53 to fill the curable material into the gap between the large diameter portion 322 of the contact pin 3 and the third section 443 of the housing 4 and the gap between the large diameter portion 412 and the second section 542 of the outer contact 5. Subsequently, by performing the curing process on the applied curable material and curing the applied curable material, the first sealing member 8a is formed so as to close the gap between the large diameter portion 322 and the third section 443 and the gap between the large diameter portion 412 and the second section 542. In this state, the gap between the contact pin 3 and the housing 4 and the gap between the housing 4 and the outer contact 5 are liquid-tightly sealed in the second cylindrical portion 53 by the first sealing member 8a. Further, at any timing prior to a step S140, the gasket 6 is mounted in the holding groove 512 of the outer contact 5.

Next, at the step S140, the cover 7 is attached to the outer contact 5. Specifically, the outer contact 5 is passed through the through-hole 73 of the cover 7 from the base side. The passing-through of the outer contact 5 into the through-hole 73 is completed when the body portion 511 of the outer contact 5 is fitted into the straight portion 731 of the cover 7 and abuts against the abutting portion 732 of the cover 7 from the base side and the fitting protrusion 513 of the outer contact 5 is fitted into the abutting portion 732. As shown in FIG. 8, in this state, the tip end surfaces of the base portion 71 and the abutting portion 732 and the tip end surface of the fitting protrusion 513 of the outer contact 5 are located on the substantially same plane. Further, the cylindrical portion 72 of the cover 7 covers the first cylindrical portion 52 of the outer contact 5 from the outer side through a gap therebetween.

Referring back to FIG. 17, at a step S150, the outer contact 5 and the cover 7 are held by the base plate 2. Specifically, the cover 7 and the outer contact 5 are placed on the tip end surface of the body portion 21 of the base plate 2 from the tip side in a posture in which the four bosses 74 of the cover 7 can respectively pass through the four fixing holes 23 of the base plate 2 and the base portion 51 of the outer contact 5 can pass through the through-hole 22 of the base plate 2. Thereafter, the thermocompression process is performed to crush the portions of the four bosses 74 protruding from the body portion 21 toward the base side, and thereby the cover 7 is fixedly held by the base plate 2. Next, the crimping areas 26 of the base plate 2 are crimped toward the inner side, and thereby the outer contact 5 is fixedly held by the base plate 2. In this state, the gasket 6 mounted in the holding groove 512 of the outer contact 5 liquid-tightly seals the gap between the base portion 51 and the through-hole 22.

Next, at a step S160, the second sealing member 8b is formed in each of the four circular recesses 25 of the base plate 2. The curable material is applied from the base side onto the bottom surface of each of the four circular recesses 25 to fill the curable material into the gap between the fixing hole 23 in each circular recess 25 and the corresponding boss 74 of the base plate 2. Subsequently, by performing the curing process on the applied curable material and curing the applied curable material, the second sealing member 8b is formed in each of the four circular recesses 25 so as to close the gap between the fixing hole 23 in each circular recess 25 and the corresponding boss 74. The gaps between the base plate 2 and the cover 7 are liquid-tightly sealed by the second sealing members 8b.

Next, at a step S170, the third sealing member 8c is formed in the cylindrical portion 72 of the cover 7. The sufficient amount of curable material is applied from the tip side onto the tip end surface of the fitting protrusion 513 of the outer contact 5 and the tip end surfaces of the base portion 71 and the abutting portion 732 of the cover 7 to fill the curable material into the gap between the fitting protrusion 513 of the outer contact 5 and the abutting portion 732 of the cover 7. Subsequently, by performing the curing process on the applied curable material and curing the applied curable material, the third sealing member 8c is formed so as to close the gap between the fitting protrusion 513 and the abutting portion 732. The gap between the outer contact 5 and the cover 7 is liquid-tightly sealed in the cylindrical portion 72 of the cover 7 by the third sealing member 8c. An execution order of the steps S160 and S170 is not particularly limited. The steps S160 and S170 may be performed in any order, or the steps S160 and S170 may be performed simultaneously. When the first sealing member 8a, the second sealing members 8b, and the third sealing member 8c are formed, the manufacturing method S100 is completed.

Although the electrical connector of the present disclosure and the method of manufacturing the electrical connector have been described based on the illustrated embodiment, the present disclosure is not limited thereto. Each configuration of the present disclosure can be replaced with any configuration capable of performing the same function, or any configuration can be added to each configuration of the present disclosure.

A person having ordinary skills in the art and the technique pertaining to the present disclosure may modify the configuration of the electrical connector of the present disclosure described above without meaningfully departing from the principle, the spirit and the scope of the present disclosure and the electrical connector having the modified configuration is also involved in the scope of the present disclosure.

Further, the number and the types of components of the electrical connector illustrated in FIGS. 4 to 16 are merely illustrative examples, and the present disclosure is not necessarily limited thereto. Aspects in which any component is added or combined or in which any component is deleted without departing from the principle and the intent of the present disclosure are also involved within the scope of the present disclosure. Further, the number and types of steps of the method of manufacturing the electrical connector shown in FIG. 17 are merely illustrative examples, and the present disclosure is not necessarily limited thereto. Aspects in which any step is added or combined for any purpose or in which any step is deleted without departing from the principle and the intent of the present disclosure are also involved within the scope of the present disclosure.

1. An electrical connector for providing a coaxial connection between a first plug connector to be inserted from a tip side and a second plug connector to be inserted from a base side, the electrical connector comprising:
a contact pin including:
a first contact portion linearly extending in an insertion and extraction direction of the first plug connector and the second plug connector and configured to contact a contact pin of the first plug connector,
a press-fitted portion extending from the first contact portion toward the base side, and
a second contact portion linearly extending from the press-fitted portion toward the base side and configured to contact a contact pin of the second plug connector;
an insulating housing including:
a holding portion into which the press-fitted portion of the contact pin is press-fitted,
a protruding portion protruding from a tip end surface of the holding portion toward the tip side and covering a base side portion of the first contact portion of the contact pin from an outer side, and
a through-hole that passes through the holding portion and the protruding portion in the insertion and extraction direction and through which the contact pin is passed;
an outer contact including:
a base portion for holding the holding portion of the housing therein,
a first cylindrical portion linearly extending from a tip end surface of the base portion toward the tip side and configured to contact an outer contact of the first plug connector,
a second cylindrical portion linearly extending from the base portion toward the base side and configured to contact an outer contact of the second plug connector, and
a through-hole that passes through the base portion, the first cylindrical portion, and the second cylindrical portion in the insertion and extraction direction and in which the contact pin and the housing are located; and
a first sealing member provided in the second cylindrical portion of the outer contact to seal a gap between the contact pin and the housing and a gap between the housing and the outer contact.

2. The electrical connector as claimed in claim 1, wherein the first sealing member seals a gap between the press-fitted portion of the contact pin and the through-hole of the housing and a gap between the holding portion of the housing and the through-hole of the outer contact.

3. The electrical connector as claimed in claim 1, further comprising:
a metal base plate including:
a plate-like body portion, and
a through-hole that is formed in the plate-like body portion so as to pass through the plate-like body portion in the insertion and extraction direction and through which the base portion of the outer contact is passed; and
an annular gasket attached to an outer peripheral surface of the base portion of the outer contact,
wherein the annular gasket seals a gap between the base portion of the outer contact and the through-hole of the metal base plate.

4. The electrical connector as claimed in claim 1, further comprising a cover that covers the first cylindrical portion of the outer contact from the outer side while being spaced apart from the first cylindrical portion,
wherein the cover includes:
a plate-like base portion,
a cylindrical portion extending from a tip end surface of the base portion toward the tip side, and
a through-hole formed in the base portion so as to pass through the base portion in the insertion and extraction direction, and
wherein the base portion of the outer contact is inserted into the through-hole of the cover so that the first cylindrical portion of the outer contact protrudes from the through-hole of the cover toward the tip side.

5. The electrical connector as claimed in claim 4, further comprising a metal base plate including:
a plate-like body portion,
a through-hole that is formed in the plate-like body portion so as to pass through the plate-like body portion in the insertion and extraction direction and through which the base portion of the outer contact is passed,
a fixing hole formed in the plate-like body portion so as to pass through the plate-like body portion in the insertion and extraction direction, and
a circular recess formed on a base end surface of the plate-like body portion so as to surround the fixing hole,
wherein the cover further includes a boss protruding from a base end surface of the base portion toward the base side, and
wherein the boss of the cover is passed through the fixing hole of the metal base plate.

6. The electrical connector as claimed in claim 5, further comprising a second sealing member provided in the circular recess of the metal base plate to seal a gap between the boss of the cover and the fixing hole of the metal base plate.

7. The electrical connector as claimed in claim 4, further comprising a third sealing member provided in the cylindrical portion of the cover to seal a gap between the base portion of the outer contact and the through-hole of the cover.

8. A method of manufacturing an electrical connector for providing a coaxial connection between a first plug connector to be inserted from a tip side and a second plug connector to be inserted from a base side, the method comprising:
holding a contact pin with a cylindrical housing by press-fitting the contact pin into the cylindrical housing;
holding the cylindrical housing with an outer contact by press-fitting the housing into the outer contact, wherein the outer contact includes:
a base portion for holding the cylindrical housing therein,
a first cylindrical portion linearly extending from a tip end surface of the base portion toward the tip side and configured to contact an outer contact of the first plug connector,
a second cylindrical portion linearly extending from the base portion toward the base side and configured to contact an outer contact of the second plug connector, and
a through-hole that passes through the base portion, the first cylindrical portion, and the second cylindrical portion in an insertion and extraction direction of the first plug connector and the second plug connector and in which the contact pin and the cylindrical housing are located; and
forming a first sealing member for sealing a gap between the contact pin and the cylindrical housing and a gap between the cylindrical housing and the outer contact in the second cylindrical portion of the outer contact.
